(19) United States
(12) Patent Application Publication
(10) Pub. No.: US 2011/0009159 A1
(43) Pub. Date: Jan. 13, 2011

(54) Method for capturing files with a portable electronic device

(76) Inventors: Hrvoje Muzina, Auckland (NZ); Mukesh Bhika, Auckland (NZ)

Correspondence Address: NORTH AMERICA INTELLECTUAL PROPERTY CORPORATION, P.O. BOX 506, MERRIFIELD, VA, 22116, US

(21) Appl. No.: 12/500,614

(22) Filed: Jul. 10, 2009

(51) Int. Cl. G06F 17/30; G06F 7/08; G01C 21/00; H04M 1/00

(52) U.S. Cl. 455/550.1; 701/213; 707/E17.01; 707/E17.044

(57) ABSTRACT

A method of capturing, cataloging, and presenting files with a portable electronic device includes capturing files having a plurality of formats of data with the portable electronic device, generating a geographical tag (geotag) based on a current location of the portable electronic device for each file with the portable electronic device and attaching the geotag to the file, generating a timestamp for each file with the portable electronic device and attaching the timestamp to the file, storing the files having the attached geotags and timestamps, and presenting the files according to corresponding geographical locations, timestamps, or formats of the files.

### BACKGROUND OF THE INVENTION

1. Field of the Invention

The invention relates to a method of for capturing and presenting files with a portable electronic device, and more particularly, to a method for capturing and presenting files having a variety of data formats with a portable electronic device.

2. Description of the Prior Art

In modern times, the device that is perhaps used most frequently for capturing events of a unique and transient nature is a camera. Most camera models can capture not just still images, moving images and sounds, but also provide time and date stamps for the files. However, keeping track of when and where the captured events occurred still requires significant additional effort and resources to capture, store, and organize required information. For example, maps, Global Positioning System (GPS) devices, filing systems, and other such devices are needed for properly documenting and organizing the captured files. Moreover, modern devices are often limited to capturing one or two types of files, and do not offer the flexibility of capturing a large variety of files.

Therefore, there is currently a need for a way to easily capture, organize, and present files of many different types in a portable electronic device that can be conveniently carried by the user.

### SUMMARY OF THE INVENTION

It is therefore one of the primary objectives of the claimed invention to provide a method of capturing, organizing, and presenting files of a plurality of formats with a portable electronic device.

According to an exemplary embodiment of the claimed invention, a method of capturing, cataloging, and presenting files with a portable electronic device is disclosed. The method includes capturing files having a plurality of formats of data with the portable electronic device, generating a geographical tag (geotag) based on a current location of the portable electronic device for each file with the portable electronic device and attaching the geotag to the file, generating a timestamp for each file with the portable electronic device and attaching the timestamp to the file, storing the files having the attached geotags and timestamps, and presenting the files according to corresponding geographical locations, timestamps, or formats of the files.

It is an advantage that the present invention provides an easy way to capture files of a variety of different formats. Moreover, the files are assigned both geotags and timestamps for providing a way to organize and sort the files by time or geographical information. Stored files can then be selected for presenting the files in a multimedia presentation.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram of a portable electronic device according to the present invention.

FIG. 2 is a chart showing various files captured by the portable electronic device and stored in memory as data.

FIG. 3 is a block diagram of a computer that may be used in conjunction with the portable electronic device according to the present invention.

FIG. 4 is a flowchart illustrating the present invention method for capturing, organizing, and presenting files.

FIG. 5 illustrates the feature of viewing a file associated with a navigation route while also viewing a map of the navigation route.

### DETAILED DESCRIPTION

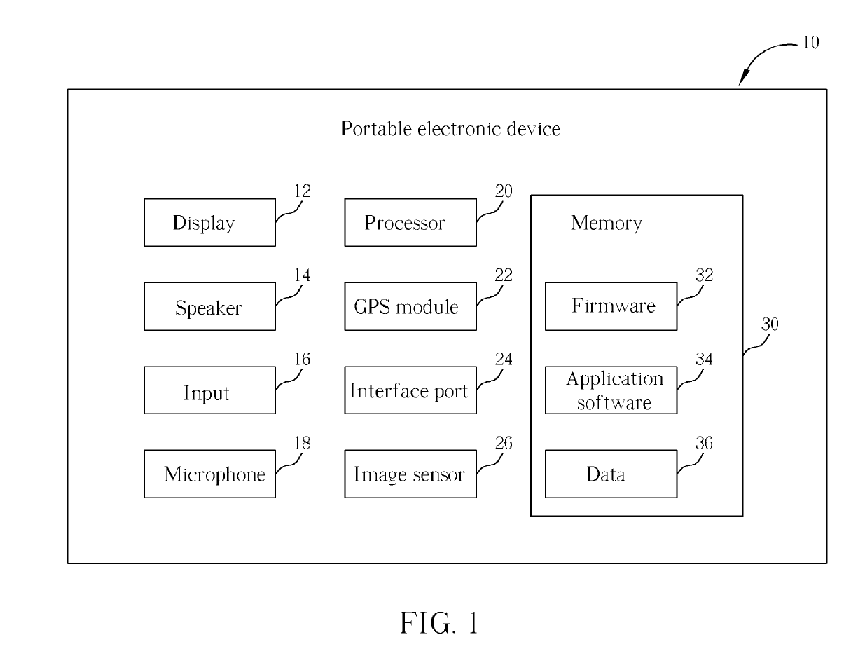

Please refer to FIG. 1. FIG. 1 is a block diagram of a portable electronic device 10 according to the present invention. The portable electronic device 10 comprises a display 12 for displaying data, a speaker 14 for outputting audio sounds, an input 16 such as control buttons and a touch-screen for inputting data into the portable electronic device 10 such as text data or sketch drawings, and a microphone 18 for inputting audio data into the portable electronic device 10. A processor 20 is used to control operation of the portable electronic device 10 and to execute firmware 32 and application software 34 stored in a memory 30 of the portable electronic device 10. The portable electronic device 10 contains a GPS module 22 for receiving the current location of the portable electronic device 10, an interface port 24 for communicating with a computer or other electronic devices, and an image sensor 26 for capturing image and video data. All files captured by the portable electronic device 10 are stored in the memory 30 as data 36.

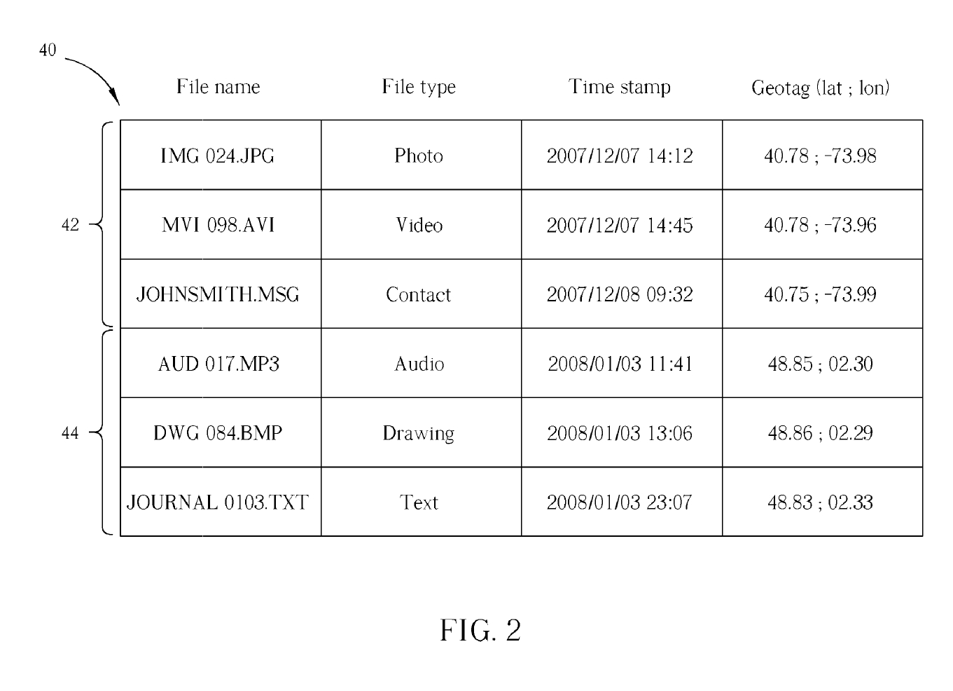

Please refer to FIG. 2. FIG. 2 is a chart 40 showing various files captured by the portable electronic device 10 and stored in the memory 30 as data 36. Six different files are shown in the chart 40, with three files belonging to a first group 42 and the other three files belonging to a second group 44. The files in the first group 42 were taken at a different time and location from the files in the second group 44.

Assume that the files in the first group 42 were taken on a trip to New York City on Dec. 7-8, 2007. A first file in the first group 42 is “IMG024.JPG”, which is a photo taken on Dec. 7, 2007 at 14:12 and having geotag information of 40.78 latitude and −73.98 longitude. A second file in the first group 42 is “MVI098.AVI”, which is a video taken on Dec. 7, 2007 at 14:45 and having geotag information of 40.78 latitude and −73.96 longitude. A third file in the first group 42 is “JOHNSMITH.MSG”, which is a file containing contact information for John Smith that was created on Dec. 8, 2007 at 09:32 and having geotag information of 40.75 latitude and −73.99 longitude.

Assume that the files in the second group 44 were taken on a trip to Paris on Jan. 3, 2008. A first file in the second group 44 is “AUD017.MP3”, which is an audio file created on Jan. 3, 2007 at 11:41 and having geotag information of 48.85 latitude and 02.30 longitude. A second file in the second group 44 is “DWG084.BMP”, which is a sketch drawing created on Jan. 3, 2007 at 13:06 and having geotag information of 48.86 latitude and 02.29 longitude. A third file in the second group 44 is “JOURNAL0101.TXT”, which is a text file created on Jan. 3, 2007 at 23:07 and having geotag information of 48.83 latitude and 02.33 longitude.

Referring back to the portable electronic device 10 shown in FIG. 1, photos can be captured with the image sensor 26, video files can be captured with the image sensor 26 and the microphone 18, and audio files can be captured with the microphone 18. Contact information files, drawing files, and text files can be created using the input 16 having control buttons and a touch-screen. When each type of file is created in the portable electronic device 10, timestamp information is added to the file and geotag information received from the GPS module 22 is also added to the file. After the timestamp information and geotag information is added to the files, the files can be sorted according to the time that they were created or according to the geographical location where they were taken. In this way, the user of the portable electronic device 10 can playback all of the files or some of the files created during a particular trip or assignment.

Travelers could use the present invention portable electronic device 10 for creating various types of multimedia files on a trip and later playing back the files as part of a digital scrapbook. News reporters could make use of the portable electronic device 10 for helping to organize files created on assignment by time or location. Traveling salesmen can also make use of the portable electronic device 10 by recording sales details, contact information, customer feedback, delivery information, product information and photos, and other such types of data.

After files have been created by the portable electronic device 10, additional notes can be associated with the files for further describing the created files. In addition, users may prefer to organize files on a computer instead of relying solely on the portable electronic device 10. In this case, files can be transferred from the memory 30 of the portable electronic device 10 to a computer via the interface port 24. The computer can be used to edit the files or to add additional files that were created by other electronic devices.

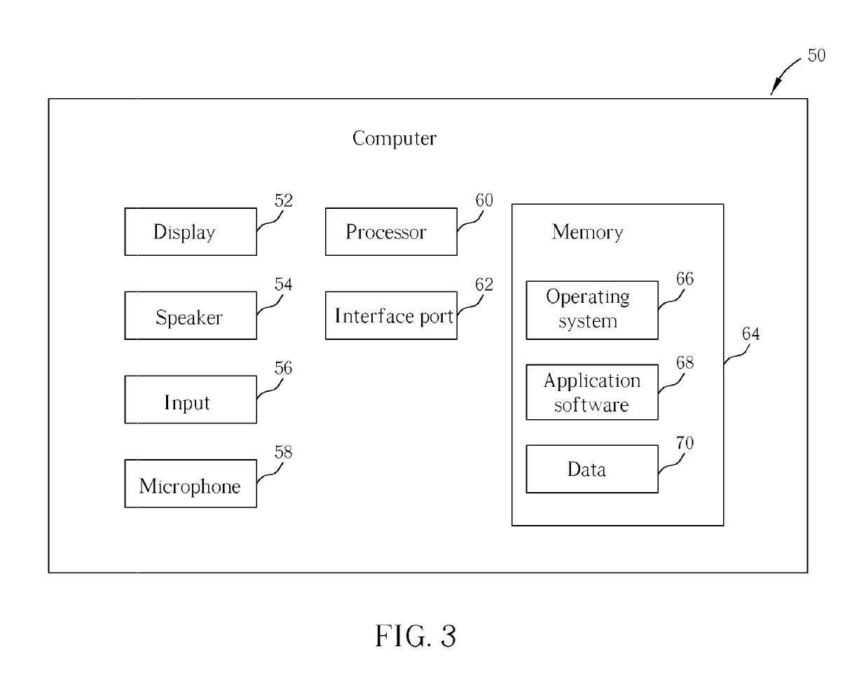

Please refer to FIG. 3. FIG. 3 is a block diagram of a computer 50 that may be used in conjunction with the portable electronic device 10 according to the present invention. The computer 50 includes a display 52 for displaying data, a speaker 54 for outputting audio sounds, an input 56 such as a keyboard or mouse for inputting data into the computer 50, and a microphone 58 for inputting audio data into the computer 50. A processor 60 is used to control operation of the computer 50 and to execute an operating system 66 and application software 68 stored in a memory 64 of the computer 50. The computer 50 contains an interface port 62 for communicating with the portable electronic device 10 via the interface port 24 of the portable electronic device 10. The computer 50 stores files in the memory 64 as data 70. As mentioned above, the computer can be used to edit the files stored in the memory 64 as data 70 or to add additional files to the data 70 section the memory 64 that were created by the computer 50 or other electronic devices. In this way, the computer 50 can be used to gather files created from a variety of sources, and can serve as a powerful platform for editing the created files.

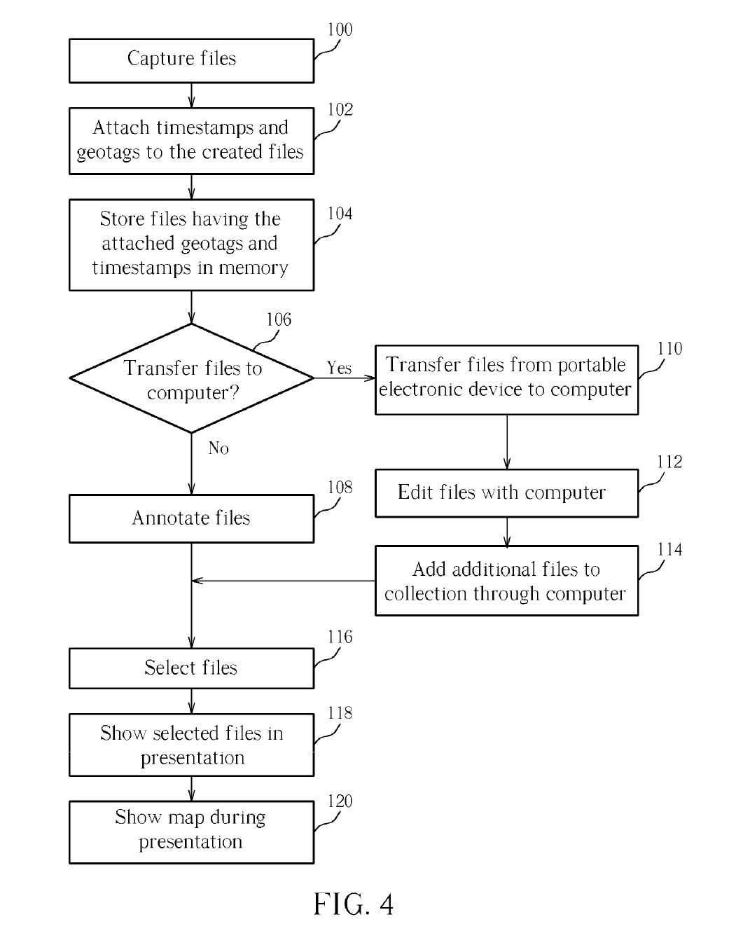

Please refer to FIG. 4. FIG. 4 is a flowchart illustrating the present invention method for capturing, organizing, and presenting files. Steps contained in the flowchart will be explained below.

Step 100: The user captures files of one or more file types with the portable electronic device 10.

Step 102: The portable electronic device 10 attaches timestamps and geotags to the created files.

Step 104: The files having the attached geotags and timestamps are stored in the memory 30 of the portable electronic device 10 as data 36.

Step 106: Determine if the user wishes to transfer files to the computer 50. If so, go to step 110. If not, go to step 108.

Step 108: The user may use the application software 34 to annotate any of the files stored in the memory 30 as data 36. Go to step 116.

Step 110: The user transfers files from the data 36 section of memory 30 of the portable electronic device 10 to the data 70 section of memory 64 of the computer 50 via the interface ports 24 and 62.

Step 112: The user may utilize the application software 68 to edit any of the files stored in the data 70 section of memory 64.

Step 114: The user may also choose to add additional files to the data 70 section the memory 64 that were created by the computer 50 or other electronic devices.

Step 116: Using either the portable electronic device 10 or the computer 50, the user may select files for viewing. The files can be sorted and selected according to the time that they were created, according to the geographical location where they were created, or according to their file types.

Step 118: The selected files are shown in a presentation. The presentation may be a multimedia presentation showing the files in their native formats, may be a movie generated from the selected files, or may be an audio presentation generated from the selected files.

Step 120: While the presentation is being given, a map may be optionally shown in a separate frame. The map may show the geographical location of where the file that is currently being displayed in the presentation was created. The time that the files were created can be shown as well. Using this feature, viewers of the presentation can instantly know when and where the files were created, thereby providing the viewers with additional context and insight when viewing the presentation.

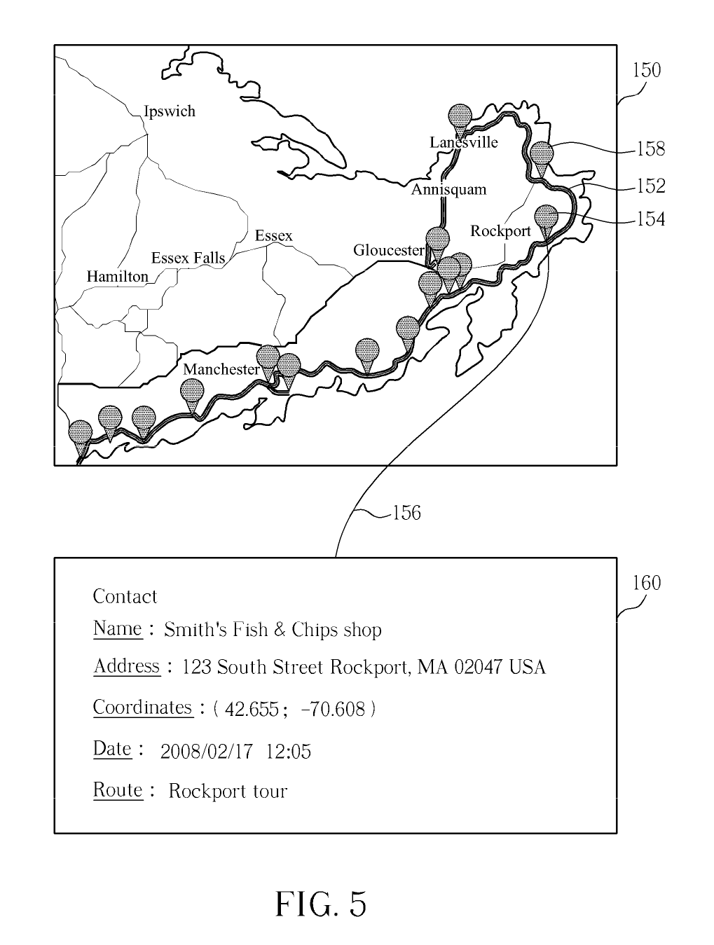

Please refer to FIG. 5. FIG. 5 illustrates the feature of viewing a file 160 associated with a navigation route 152 while also viewing a map 150 of the navigation route 152. The map 150 shows the navigation route 152 along with markers 158 indicating the locations where files were created with the portable electronic device 10. In this instance, the navigation route 152 has been given the name “Rockport tour” since the route is located around the area of Rockport, Mass., USA.

When viewing a presentation of the files created on the navigation route 152, the files can be viewed in one frame and the map 150 can be viewed in another frame. For example, in FIG. 5 file 160 represents a contact entry related to a restaurant located on the navigation route 152 at marker 154. A connecting line 156 can be shown on the presentation for indicating that the file 160 was created at the position indicated by marker 154. Since the file 160 is a contact file, it can store the name of the contact, the address, the latitude and longitude coordinates, the date created, as well as the name of the route during which the file was created.

In practice, the portable electronic device 10 may be a smartphone, a personal digital assistant (PDA), or a personal navigation device. In each case, the portable electronic device 10 should have GPS functionality or an alternative way of providing geotag information for the created files.

In summary, the present invention provides an easy way to capture files of a variety of different formats. Since both timestamps and geotags are attached to the files, the files can be organized and sorted by time or geographical information. Presentations can then be given for files created during a specific time period, for files created at a certain geographical location, or for files of a certain type.

Those skilled in the art will readily observe that numerous modifications and alterations of the device and method may be made while retaining the teachings of the invention.

What is claimed is:

1. A method of capturing, cataloging, and presenting files with a portable electronic device, the method comprising:
capturing files having a plurality of formats of data with the portable electronic device;
generating a geographical tag (geotag) based on a current location of the portable electronic device for each file with the portable electronic device and attaching the geotag to the file;
generating a timestamp for each file with the portable electronic device and attaching the timestamp to the file;
storing the files having the attached geotags and timestamps; and
presenting the files according to corresponding geographical locations, timestamps, or formats of the files.

2. The method of claim 1, wherein presenting the files comprises sorting the files according to times indicated by the timestamps attached to the files and playing the files in the order that they are sorted.

3. The method of claim 1, wherein presenting the files comprises sorting the files according to geographical locations indicated by the geotags attached to the files and playing the files in the order that they are sorted.

4. The method of claim 1, wherein presenting the files comprises playing back all formats of the stored files.

5. The method of claim 1, wherein presenting the files comprises playing back selected formats of the stored files.

6. The method of claim 1, wherein the files having the plurality of formats comprise audio files, photos, video files, or drawing image files.

7. The method of claim 1, wherein the files having the plurality of formats comprise text files or contact information files.

8. The method of claim 1 further comprising adding annotated notes to the stored files.

9. The method of claim 1 further comprising transferring the stored files from the portable electronic device to a computer for viewing the files on the computer.

10. The method of claim 9 further comprising editing the files using the computer.

11. The method of claim 9 further comprising adding additional files captured from other sources to the computer.

12. The method of claim 1, wherein presenting the files comprises generating reports containing data from selected files.

13. The method of claim 1, wherein presenting the files comprises generating movies containing data from selected files.

14. The method of claim 1, wherein presenting the files comprises generating audio presentations containing data from selected files.

15. The method of claim 1, wherein presenting the files comprises displaying maps of geographical locations corresponding to files when viewing the files.

16. The method of claim 1 further comprising associating a route name with files created with the portable electronic device, wherein the files are created while traveling on a route having the associated route name.

17. The method of claim 16, wherein presenting the files comprises viewing files associated with a given route while displaying a map of locations visited along the given route, wherein a position where each file was created is indicated on the map while viewing the file.

18. The method of claim 17, wherein the timestamp for each file is shown while presenting the file and indicating the position where the file was created on the map.

19. The method of claim 1, wherein the portable electronic device is a smartphone having Global Positioning System (GPS) functionality.

20. The method of claim 1, wherein the portable electronic device is a personal navigation device having Global Positioning System (GPS) functionality.
